(19) United States
(12) Patent Application Publication
(10) Pub. No.: US 2009/0145899 A1
(43) Pub. Date: Jun. 11, 2009

(54) CAPLESS REFUELING SYSTEM COVER WITH LOCKING MECHANISM

(75) Inventors: Robert Philip Benjey, Dexter, MI (US); Carl Binder, Ann Arbor, MI (US)

Correspondence Address: QUINN LAW GROUP, PLLC, 39555 ORCHARD HILL PLACE, SUITE # 520, NOVI, MI, 48375, US

(73) Assignee: EATON CORPORATION, Cleveland, OH (US)

(21) Appl. No.: 12/137,020

(22) Filed: Jun. 11, 2008

Related U.S. Application Data
(60) Provisional application No. 61/012,187, filed on Dec. 7, 2007.

(51) Int. Cl. B67C 3/00

(52) U.S. Cl. 220/86.2

(57) ABSTRACT

A fill neck cover for a capless refueling system is provided with a locking mechanism that selectively blocks lateral movement of the cover to prevent access to the filler neck opening and may be selectively unlocked to allow lateral movement of the cover such that the fill nozzle may be inserted into the fill opening.

### CROSS-REFERENCE TO RELATED APPLICATIONS

This application claims the benefit of U.S. Provisional Application 61/012,187, filed Dec. 7, 2007, which is hereby incorporated by reference in its entirety.

### TECHNICAL FIELD

The invention relates to a capless refueling system including a locking mechanism to selectively lock a fill neck cover.

### BACKGROUND OF THE INVENTION

Capless refueling systems typically provide a protective door cover to prevent contaminants from entering a fuel system fill neck. Some capless refueling systems allow a vehicle user to refuel a fuel tank without touching any part of the system except the nozzle.

### SUMMARY OF THE INVENTION

A capless refueling system is provided with a selectively lockable fill neck cover. A fill neck defines a fill opening configured to receive a fuel-dispensing nozzle. A fill neck cover is provided with a door portion that is configured to be linearly movable from a closed position to an open position. In some embodiments, the linear movement may be accomplished by force of the fuel dispensing nozzle when the nozzle is pressed against the cover and inserted into the fill opening. The door portion substantially covers the fill opening when in the closed position and substantially uncovers the fill opening when in the open position. As used herein, “linearly movable” means that the cover moves in a substantially non-arcuate (i.e., non-pivoting) fashion. One example of linear motion of the door portion is linear motion in a lateral direction with respect to the fill opening. As used herein “laterally movable” means that the cover moves in a substantially non-arcuate fashion, outward from a center axis of the fill opening.

A locking mechanism is provided that is selectively lockable to at least partially block linear movement of the door portion, thereby preventing insertion of the fuel dispensing nozzle through the fill opening. Any type of locking mechanism may be used, as long as the locking mechanism interferes with linear movement of the door portion when locked and allows linear movement of the door portion when unlocked. For example, the locking mechanism may have a pin-type protrusion configured to interfere with movement of the cover when the locking mechanism is locked. In one embodiment, the locking mechanism includes a key and a key shaft configured to receive the key. The key shaft is movable from an unlocked to a locked position when the key is received in the key shaft. A protrusion extending from the key shaft is moved from a first position to a second position when the key shaft is moved from the unlocked to the locked position. The pin interferes with linear movement of the cover when in the second position, and allows linear movement of the cover when in the first position.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective exploded view of a capless refueling system with a fill neck cover and locking mechanism;

FIG. 2 is a schematic bottom view of the fill neck cover of FIG. 1 supported in a cover support;

FIGS. 3A and 3B are schematic top views of the fill neck cover with a door portion of the cover shown in a closed position in FIG. 3A and in an open position in FIG. 3B;

FIG. 4 is a schematic cross-sectional view of the fill neck cover taken at the lines 4-4 in FIG. 5 showing a bore for a key shaft with tumblers;

FIG. 5 is a schematic top fragmentary view of the body portion of the cover of FIG. 3A and 3B with the locking mechanism removed; and

FIG. 6 is a schematic cross-sectional fragmentary view of the cover body taken at the arrows 6-6 in FIG. 3A.

### DESCRIPTION OF THE PREFERRED EMBODIMENTS

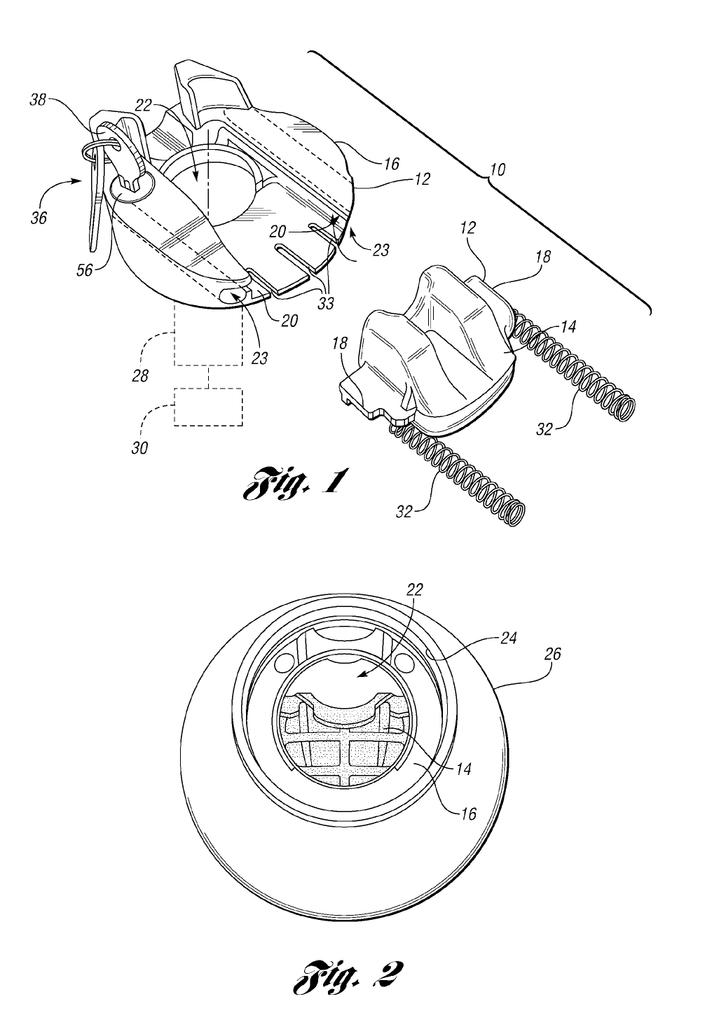

Referring to the drawings wherein like reference numbers refer to like components throughout the several views, FIG. 1 shows a capless refueling system 10. The capless refueling system 10 includes a fill neck cover 12 that includes a door portion 14, also referred to as a closure, and a base portion 16. The door portion 14 is supported on a base portion 16. The door portion 14 includes side extensions 18 configured to be retained within slots 20 formed or machined in the base portion 16. Base portion 16 forms a cover opening 22.

Referring to FIG. 2, the cover opening 22 is sufficiently aligned with a fill opening 24 formed in a cover support 26 such that a fill nozzle inserted through the cover opening 22 will extend through the fill opening 24 into a fill neck 28 (shown schematically in phantom in FIG. 1) operatively connected thereto. The door portion 14 is shown partially opened in FIG. 2. The cover support 26 is connected at an upper end of the fill neck 28. Base portion 16 sits in the cover support 26. (The cover support 26 is removed from the base portion 16 and not shown in FIG. 1.) The fill neck 28 is operatively connected to a fuel tank 30, also shown schematically in phantom. Those skilled in the art will readily understand and be familiar with known fuel tank configurations and recognize their ability to be used with the capless refueling system 10.

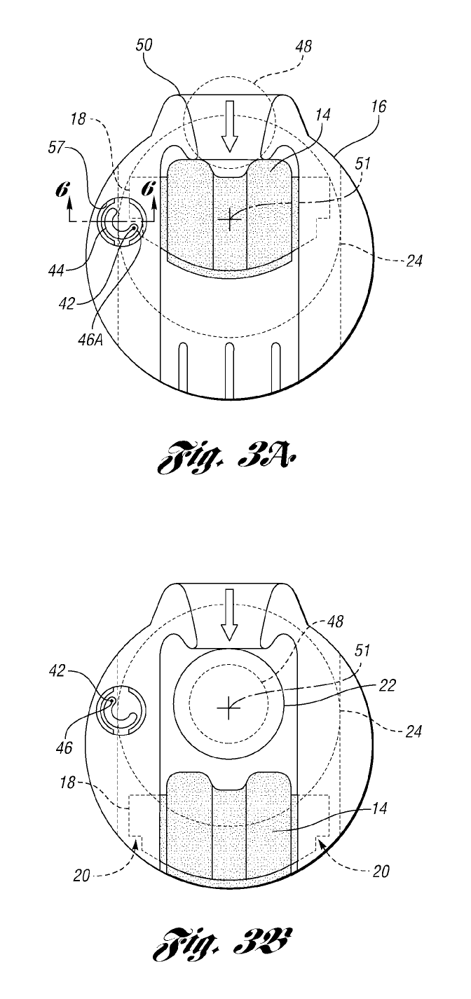

Springs 32 are configured to rest within channels 23 of the base portion 16, between the door portion 14 and the cover support 26. The opening of the left-most channel in FIG. 1 is partially visible. The channel 23 runs partially through the base portion 16, as illustrated with a dashed line in FIG. 1. The channel 23 on the right in FIG. 1 is also illustrated with a dashed line. The springs 32 are biasing members captured between the cover support 26 and a surface of the door portion 14 and may bias the door portion 14 to a closed position of FIG. 3B. Drain openings 33 are formed in the base portion 16 to promote draining of water from the cover 12 when installed on a vehicle.

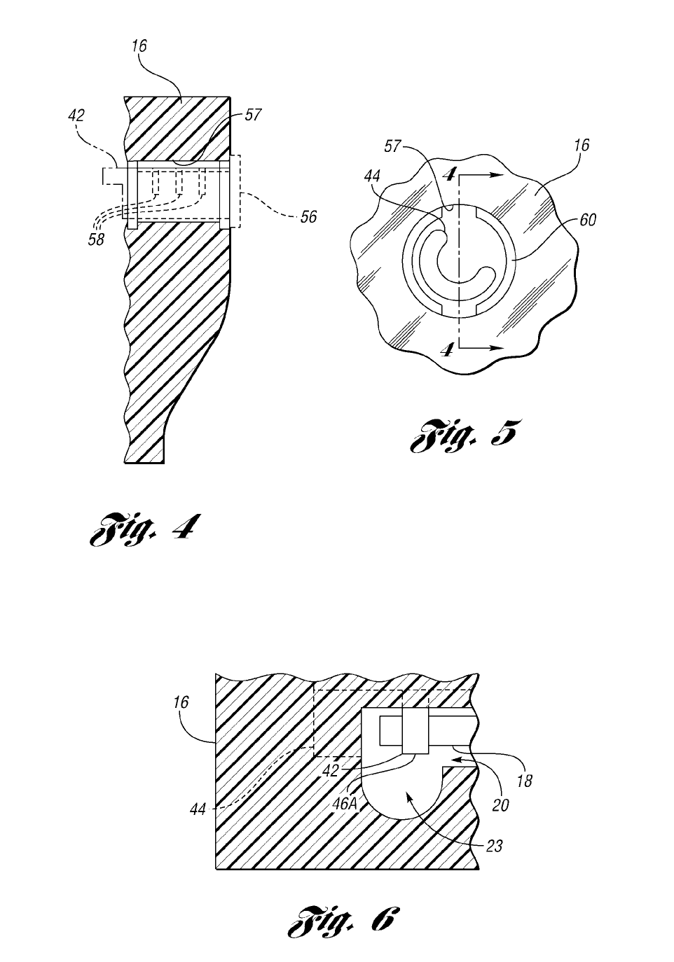

Referring to FIG. 1, a locking mechanism 36 is supported in the base portion 16. In this embodiment, the locking mechanism 36 includes a key 38 and a key shaft 56 supported in a bore 57 (shown in FIG. 3A) of body portion 16. The locking mechanism 36 is movable from an unlocked to a locked position when the key 38 is received in the key shaft 56. Referring to FIG. 4, a pin 42 extends from the end of the key shaft 56 (both shown in phantom). Referring to FIG. 3A, the body portion 16 is formed with an internal curved slot 44 below the bore 57. The slot 44 inhibits movement of the pin 42 to move only from a non-interfering position 46 (i.e., a first position, shown in FIG. 3B) corresponding with an unlocked position of the key 38 to an interfering position 46A (i.e., a second position shown in FIG. 3A) corresponding with a locked position of the key 38. (In FIGS. 3A and 3B, only the pin 42 is shown, with the key shaft 56 removed in order to view the slot 44.) In the non-interfering position 46, the door portion 14, and particularly the extension 18 thereof, is not blocked or restricted from lateral movement by the pin 42. Thus, when the tip of fill nozzle 48 is pressed against the door portion 14 and against the protrusions 50 formed in the body portion 16 and toward the fill opening 24, as illustrated in phantom in FIG. 3A, force of the nozzle 48 will cause lateral movement of the door portion 14 laterally outward from a central axis 51 of the fill opening 24 to an open position illustrated in FIG. 3B. The base portion 16 may be configured with a protruding or cam surface so that the door portion 14 moves laterally when a fill nozzle is pressed against the door portion 14 toward the fill opening and the locking mechanism is unlocked. With the door portion 14 in the open position, the cover opening 22 is uncovered and the fill nozzle 48 (represented only with a phantom circle indicating the tip thereof in FIG. 3B) may extend through the fill opening 24 in order to dispense fuel into the fill neck 28 and fuel tank 30 of FIG. 1.

Referring to FIG. 4, the base portion 16 is formed with an internal bore 57 sized to receive the key shaft 56 with the pin 42 extending therefrom. The key shaft 56 supports tumblers or pins 58, as is standard with key and tumbler-type locking mechanisms. The tumblers 58 prevent the key shaft 56 from rotating due to interference with radially extending features 60 in the bore 57. Insertion of the key 38 moves the tumblers 58 out of interference with the features 60 and allows the key shaft 56 to rotate such that the pin 42 moves between the interfering position 46A and the non-interfering position 46 of FIGS. 3A and 3B. It should be appreciated that any type of locking mechanism may be utilized, including a locking mechanism that actuates a pin axially rather than rotationally to interfere with the door portion 14. Additionally, a torsion spring or other biasing mechanism may be used to bias the key shaft 56 to the unlocked or to the locked position if desired.

Referring to FIG. 6, the body portion 16 is shown with the pin 42 in the interfering position 46A within the slot 44 shown in phantom. The extension 18 of the door portion 14 is shown within the slot 20 above the channel 23.

Thus a fill neck cover 12 for a capless refueling system 10 is provided with a locking mechanism 36 that selectively blocks lateral movement of the cover 12 (i.e., door portion 14 of the cover 12) to prevent access to the filler neck opening 24 and may be selectively unlocked to allow lateral movement of the door portion 14 such the fill nozzle 48 may be inserted into the fill opening 24.

While the best modes for carrying out the invention have been described in detail, those familiar with the art to which this invention relates will recognize various alternative designs and embodiments for practicing the invention within the scope of the appended claims.

1. A capless refueling system having a fill neck defining a fill opening configured to receive a fuel-dispensing nozzle, comprising:
a fill neck cover having a door portion configured to be linearly movable from a closed position to an open position via the fuel-dispensing nozzle when the nozzle is pressed against the cover toward the opening; wherein the door portion substantially covers the fill opening in the closed position and substantially uncovers the fill opening in the open position; and
a locking mechanism selectively lockable to at least partially block linear movement of the door portion and thereby prevent insertion of the fuel-dispensing nozzle through the fill opening.

2. The capless refueling system of claim 1, further comprising:
at least one biasing member configured to bias the door portion toward the closed position.

3. The capless refueling system of claim 1, wherein the cover has a base portion defining a cover opening positioned with respect to the fill opening such that the nozzle extends through the cover opening when the fuel dispensing nozzle is inserted through the fill opening; and wherein the door portion substantially covers the cover opening when the door portion is in the closed position and substantially uncovers the cover opening when the door portion is in the open position.

4. The capless refueling system of claim 1, wherein the locking mechanism has a protrusion configured to interfere with the door portion when the locking mechanism is locked.

5. The capless refueling system of claim 1, wherein the locking mechanism includes a key and a key shaft; wherein the key shaft is configured to receive the key and is movable from an unlocked to a locked position when the key is received in the key shaft; wherein the key shaft has a pin extending from the key shaft that is moved from a first position to a second position when the key shaft is moved from the unlocked to the locked position; and wherein the pin interferes with linear movement of the cover when in the second position.

6. An apparatus for selectively covering a fill opening defined by a fuel system fill neck, comprising:
a cover having:
a base portion operatively connectable to the fill neck and defining a cover opening in at least partial alignment with the fill opening; and
a door portion supported on the base portion and selectively laterally movable with respect to the base portion to cover and uncover the cover opening; and
a locking mechanism selectively lockable and configured to interfere with lateral movement of the door portion when locked to thereby prevent uncovering the cover opening.

7. The apparatus of claim 6, wherein the base portion has a laterally-extending slot; wherein the door portion has an extension configured to extend within the slot; and wherein the extension slides laterally within the slot when the door portion moves laterally with respect to the base portion.

8. The apparatus of claim 6, wherein the base portion has a laterally-extending channel below the slot; and further comprising:
a biasing member within the channel configured to bias against the lateral movement of the door portion.

9. The apparatus of claim 6, wherein the locking mechanism has a protrusion configured to interfere with the door portion when the locking mechanism is locked.

10. The apparatus of claim 6, wherein the locking mechanism includes a key and a key shaft; wherein the key shaft is configured to receive the key and is movable from an unlocked to a locked position when the key is received in the key shaft; wherein the key shaft has a pin extending from the key shaft that is moved from a first position to a second position when the key shaft is moved from the unlocked to the locked position; and wherein the pin interferes with lateral movement of the cover when in the second position.

11. An apparatus for selectively covering a fill opening defined by a fuel system fill neck, comprising:
a cover having:
a base portion operatively connectable to the fill neck and defining a cover opening in at least partial alignment with the fill opening; and p2 a door portion supported on the base portion and selectively laterally movable with respect to the base portion to cover and uncover the cover opening; and
a locking mechanism selectively lockable and configured to interfere with lateral movement of the door portion when locked to thereby prevent uncovering the cover opening; wherein the base portion has a laterally-extending slot; wherein the door portion has an extension configured to extend within the slot; wherein the extension slides laterally within the slot when the door portion moves laterally with respect to the base portion; and wherein the locking mechanism has a protrusion configured to interfere with lateral sliding of the door portion when the locking mechanism is locked.
